(19) United States
(12) Patent Application Publication
(10) Pub. No.: US 2010/0276550 A1
(43) Pub. Date: Nov. 4, 2010

(54) TUBE SUPPORT STRUCTURE

(76) Inventors: Richard G. Klarner, Georgetown (CA); Ghasem V. Asadi, Cambridge (CA)

Correspondence Address: BABCOCK & WILCOX POWER GENERATION GROUP, INC., PATENT DEPARTMENT, 20 SOUTH VAN BUREN AVENUE, BARBERTON, OH, 44203, US

(21) Appl. No.: 12/432,644

(22) Filed: Apr. 29, 2009

(51) Int. Cl. F16L 5/00; B23P 15/00

(52) U.S. Cl. 248/56; 29/890.14

(57) ABSTRACT

A tube support plate with an offset pattern of tube receiving holes formed therein, the pattern being offset from either the X or Y axis of the tube support plate. One half of the offset pattern of tube receiving holes is on one side of the selected axis and the other half is on the other side of the selected axis. The offset pattern of tube receiving holes is the result of an increased pitch between pattern halves at the selected axis.

### FIELD AND BACKGROUND OF INVENTION

The present invention relates generally to nuclear steam generators, and in particular to a new and useful tube support system and method for use in nuclear steam generators which employ tube support plates to retain the tube array spacing within the steam generator.

The pressurized steam generators, or heat exchangers, associated with nuclear power stations transfer the reactor-produced heat from the primary coolant to the secondary coolant, which in turn drives the plant turbines. These steam generators may be about 75 feet long and have an outside diameter of about 12 feet. Within one of these steam generators, straight tubes, through which the primary coolant flows, may be typically ⅝ inch in outside diameter, but have an effective length of 52 feet or longer between the tube-end mountings and the opposing faces of the tube sheets. Typically, there may be a bundle of more than 15,000 tubes in one of these steam generators. It is clear that there is a need to provide structural support for these tubes, such as a tube support plate, in the span between the tube sheets to ensure tube separation, adequate rigidity, and the like.

U.S. Pat. No. 4,204,305 describes a nuclear steam generator commonly referred to as a Once Through Steam Generator (OTSG), the text of which is hereby incorporated by reference as though fully set forth herein. A Once Through Steam Generator contains a tube bundle consisting of straight tubes. The tubes are laterally supported at several points along their lengths by tube support plates. The tubes pass through tube support plate holes having three inwardly protruding lands or tube contact surfaces for the purpose of laterally supporting the tubes, and three bights that are intermediate of the inwardly protruding lands and formed in the individual support plate (TPS) holes when the tube associated therewith is lodged in place to establish secondary fluid flow passages through the support plate. It is generally recognized that after a heat exchanger is assembled, the tubes will contact one or two of the inwardly protruding lands of the tube support plate holes. This contact provides lateral support to the tube bundle to sustain lateral forces such as seismic loads, while also providing support to mitigate tube vibration during normal operation. It has been found, after long periods of operation, that deposits consisting primarily of magnetite are formed at the tube support plates. These deposits block or partially block the bights formed between the inwardly protruding members, and thus cause undesirable increases in secondary fluid flow pressure drop.

U.S. Pat. No. 6,914,955 B2 describes a tube support plate suitable for use in the aforementioned Once Through Steam Generator, the text of which is hereby incorporated by reference as though fully set forth herein. This support plate is fabricated from a stronger and more corrosive resistant material such as stainless steel, the broached tube holes in the support plate are hour glass shaped, and the inwardly protruding lands are flat. These improvements minimize pressure drop by reducing local turbulence and are less likely to cause the deposition of magnetite and other particles on the surface of the support plates. To facilitate the assembly of the tube bundle and more specifically the insertion of the tubes during the assembly process, the alignment of the tube support plates is maintained by alignment blocks situated around the perimeter of the support plates between the plates and the inner surface of the shroud or baffle. The alignment blocks are fixed to the shroud or the tube support plates, but not to both. Clearance may be provided at the alignment blocks between the tube support plates and the shroud to allow vertical movement. The shroud which is generally a large continuous cylinder is laterally supported within the Once Through Steam Generator pressure vessel shell by shroud alignment pins. This support arrangement provides a lateral load path from the tubes, through the tube support plates, to the shroud which is in turn supported by the pressure vessel shell.

Experimental work has demonstrated that small misalignment between consecutive tube support plate tube holes is effective in negating tube vibration. A previous method of implementing tube support plate tube hole offsets is to fabricate all of the tube support plates with the same tube hole pattern and, during the assembly of the tube bundle, to alternately offset consecutive tube support plates within the shroud to achieve the desired tube hole offset pattern. This previous method uses blocks around the perimeter of the tube support plate to hold the individual tube support plates at their shifted locations within the shroud. All tubes which pass through the offset tubular support plates have essentially the same offset pattern; consequently all tubes passing through an individual tube support plate react in the same direction as the tube support plate. The contacts between the respective tubes and holes at individual locations are dependent upon the magnitude of the imposed offset and are designed to be large enough to mitigate tube vibration. The offsets must be controlled to ensure that they are not excessively large such that, during the assembly of the tube bundle, tubes can still be readily inserted through the tube support plates while the support plates are held in their offset arrangement.

The unidirectional loading of a plurality of tubes, used by this previous method, will cause a large net reaction load at the individual tube support plates. The large lateral tube support plate loads resulting from the offset position of the tubular support plates will react against the inside wall of the shroud through the blocks which position the tube support plates. The contact forces between the shroud and the tube support plates are capable of generating significant frictional loads when the tube support plates slide vertically within the shroud as is expected during operational thermal cycles.

For a general description of the characteristics of nuclear steam generators, the reader is referred to Chapter 48 of Steam/its generation and use, 41st Edition, Kitto and Stultz, Eds., © 2005 The Babcock & Wilcox Company, Barberton, Ohio, U.S.A., the text of which is hereby incorporated by reference as though fully set forth herein.

### SUMMARY OF INVENTION

The present invention is drawn to an improved system and method for supporting tubes in a Once Through Steam Generator for a nuclear power plant.

According to the invention, there is provided a tube bundle support system and method which advantageously permits tube support plates to be installed in an aligned configuration that is compatible with normal fabrication processes.

One aspect of the invention is drawn to the manufacture of a flat support plate having an offset pattern of individual tube receiving holes formed therein, the pattern being offset from either the X or Y axis of the support plate. One half of the offset pattern of tube receiving holes is on one side of the selected axis and the other half is on the other side of the selected axis. The offset pattern of tube receiving holes is the result of an increased pitch between pattern halves at the selected axis.

Another aspect of the invention is drawn to the method of manufacturing the tube support plate which includes selecting either the X or Y axis of the tube support plate and forming, in the support plate, an offset pattern of tube receiving holes. Dividing the offset pattern of tube receiving holes into two halves, and locating one half of the pattern of tube receiving holes on one side of the selected axis and the other half on the other side of the selected axis, and offsetting the pattern of tube receiving holes by increasing the pitch between pattern halves at the selected axis.

A further aspect of the invention is drawn to a tube support system for use in a heat exchanger having a cylindrical pressure vessel, a plurality of tubes in spaced parallel relation for flow of fluid there through in indirect heat transfer relation with a fluid flowing there over, a shroud disposed within the pressure vessel and surrounding the tubes, the tube support system comprising a plurality of first and second tube support plates disposed transverse to the tubes, the first support plates having a uniform pattern of tube receiving holes and the second support plates having an offset pattern of tube receiving holes. The first tube support plates are placed in spaced alternating fashion with the second support plates.

The pattern in each of the second tube support plates is offset from either the X or Y axis of the support plate, and one half of the offset pattern of tube receiving holes is on one side of the selected axis and the other half is on the other side of the selected axis. The pattern of tube receiving holes is offset by increasing the pitch between the pattern halves at the selected axis.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which reference numbers are used to refer to the same or functionally similar elements:

FIG. 1 is a sectional side view of a prior art once-through steam generator whereon the principles of the present invention may be practiced;

FIG. 2 is a schematic side view of a prior art arrangement of alternately offset consecutive tube support plates;

FIG. 3 is a schematic plan view of a tube support plate with a uniform pattern of tube receiving holes, and of a tube support plate with an offset pattern of tube receiving holes;

FIG. 4 is a plan view of a portion of a support plate with an offset pattern of tube receiving holes; and

FIG. 5 is a schematic side view of an arrangement of tube support plates with a uniform pattern of tube receiving holes placed in spaced alternating fashion with tube support plates with an offset pattern of tube receiving holes.

### DESCRIPTION OF THE PREFERRED EMBODIMENTS

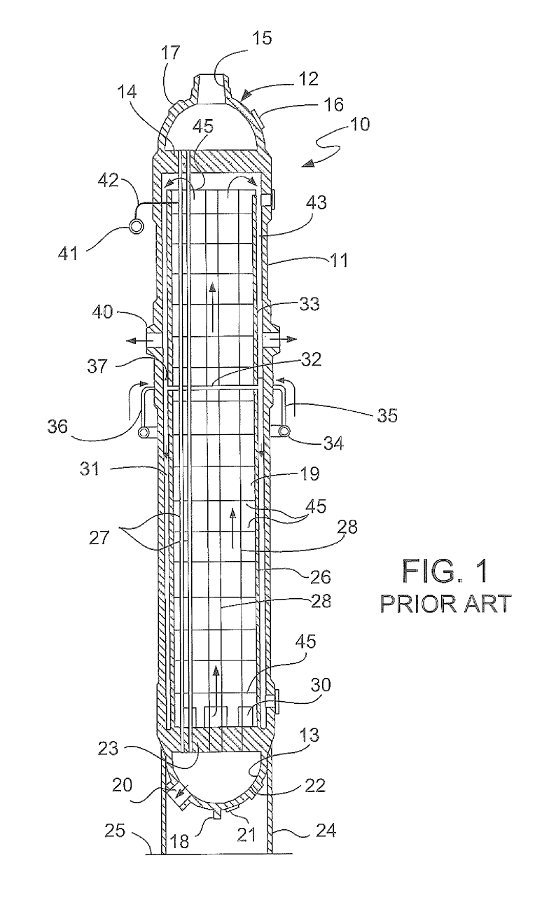

FIG. 1 depicts a prior art once-through steam generator 10 comprising a vertically elongated, cylindrical pressure vessel or shell 11 closed at its opposite ends by an upper head 12 and a lower head 13.

The upper head includes an upper tube sheet 14, a primary coolant inlet 15, a manway 16 and a hand hole 17. The manway 16 and the hand hole 17 are used for inspection and repair during times when the steam generator 10 is not in operation. The lower head 13 includes drain 18, a coolant outlet 20, a hand hole 21, a manway 22 and a lower tube sheet 23.

The steam generator 10 is supported on a conical or cylindrical skirt 24 which engages the outer surface of the lower head 13 in order to support the steam generator 10 above structural flooring 25.

The overall length of a typical steam generator of the sort under consideration is about 75 feet between the flooring 25 and the upper extreme end of the primary coolant inlet 15. The overall diameter of the unit 10 moreover, is in excess of 12 feet.

Within the shell 11, a lower cylindrical tube shroud, wrapper or baffle 26 encloses a bundle of heat exchanger tubes 27, a portion of which is illustrated in FIG. 1. In a steam generator of the type under consideration moreover, the number of tubes enclosed within the shroud 26 is in excess of 15,000, each of the tubes having an outside diameter of ⅝ inch. It has been found that Alloy 690 is a preferred tube material for use in steam generators of the type described. The individual tubes 27 in the tube bundle each are anchored in respective holes formed in the upper and lower tube sheets 14 and 23 through belling, expanding or seal welding the tube ends within the tube sheets.

The lower shroud 26 is aligned within the shell 11 by means of shroud alignment pins. The lower shroud 26 is secured by bolts to the lower tubesheet 23 or by welding to lugs projecting from the lower end of the shell 11. The lower edge of the shroud 26 has a group of rectangular water ports 30 or, alternatively, a single full circumferential opening (not shown) to accommodate the inlet feedwater flow to the riser chamber 19. The upper end of the shroud 26 may also establish fluid communication between the riser chamber 19 within the shroud 26 and annular downcomer space 31 that is formed between the outer surface of the lower shroud 26 and the inner surface of the cylindrical shell 11 through a gap or steam bleed port 32.

A support rod system 28 is secured at the uppermost of the support plates 45, and consists of threaded segments (also referred to as tie rods) spanning between the lower tubesheet 23 and the lowest of the support plates 45 and thereafter between all support plates 45 up to the uppermost support plate 45.

A hollow, toroid shaped secondary coolant feedwater inlet header 34 circumscribes the outer surface of the shell 11. The header 34 is in fluid communication with the annular downcomer space 31 through an array of radially disposed feedwater inlet nozzles 35. As shown by the direction of the FIG. 1 arrows, feedwater flows from the header 34 into the steam generator unit 10 byway of the nozzles 35 and 36. The feedwater is discharged from the nozzles downwardly through the annular downcomer 31 and through the water ports 30 into the riser chamber 19. Alternatively, feedwater may be introduced through two large feedwater nozzles (not shown) directly into the annular downcomer 31 thereby eliminating the external feedwater header 34 and radially disposed inlet nozzles 35 and 36, such as in the case of integral economizer OTSGs; i.e., IEOTSGs. Within the riser chamber 19, the secondary coolant feedwater flows upwardly within the shroud 26 in a direction that is counter to the downward flow of the primary coolant within the tubes 27. An annular plate 37, welded between the inner surface of the shell 11 and the outer surface of the bottom edge of an upper cylindrical shroud, baffle or wrapper 33 insures that feedwater entering the downcomer 31 will flow downwardly toward the water ports 30 in the direction indicated by the arrows. The secondary fluid absorbs heat from the primary fluid through the tubes 27 in the tube bundle and rises to steam within the chamber 19 that is defined by the shrouds 26 and 33.

The upper shroud 33, also aligned with the shell 11 by means of alignment pins (not shown in FIG. 1), is fixed in an appropriate position because it is welded to the shell 11 through the plate 37, immediately below steam outlet nozzles 40. The upper shroud 33, furthermore, enshrouds at least one third of the length of the tubes 27, such as in the case of IEOTSGs.

An auxiliary feedwater header 41 is in fluid communication with the upper portion of the tube bundle through one or more nozzles 42 that penetrate the shell 11 and the upper shroud 33. This auxiliary feedwater system is used, for example, to fill the steam generator 10 in the unlikely event that there is an interruption in the feedwater flow from the header 34. As mentioned above, the feedwater, or secondary coolant that flows upwardly through the tubes 27 in the direction shown by the arrows rises into steam. In the illustrative embodiment, moreover, this steam is superheated before it reaches the top edge of the upper shroud 33. This superheated steam flows in the direction shown by the arrow, over the top of the shroud 33 and downwardly through an annular outlet passageway 43 that is formed between the outer surface of the upper cylindrical shroud 33 and the inner surface of the shell 11. The steam in the passageway 43 leaves the steam generator 10 through steam outlet nozzles 40 which are in communication with the passageway 43. In this foregoing manner, the secondary coolant is raised from the feed water inlet temperature through to a superheated steam temperature at the outlet nozzles 40. The annular plate 37 prevents the steam from mixing with the incoming feedwater in the downcomer 31. The primary coolant, in giving up this heat to the secondary coolant, flows from a nuclear reactor (not shown) to the primary coolant inlet 15 in the upper head 12, through individual tubes 27 in the heat exchanger tube bundle, into the lower head 13 and is discharged through the outlet 20 to complete a loop back to the nuclear reactor which generates the heat from which useful work is ultimately extracted.

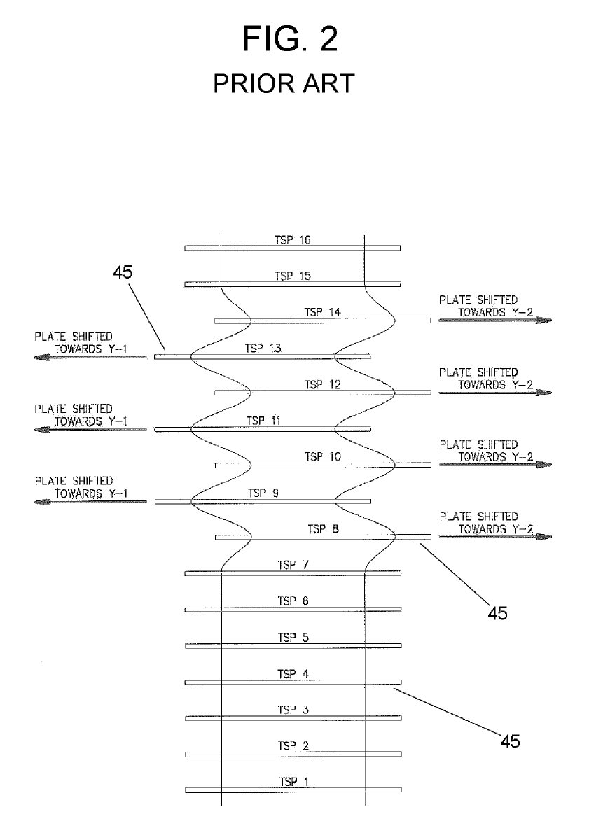

Referring to FIG. 2, there is schematically shown a prior art arrangement for implementing tube support plate hole offsets. In this arrangement, all of the tube support plates 45 are fabricated with the same uniformly spaced tube hole pattern. During assembly of the tube bundle within the shroud, consecutive tube support plates 45 are alternately offset to achieve the desired tube hole offset pattern.

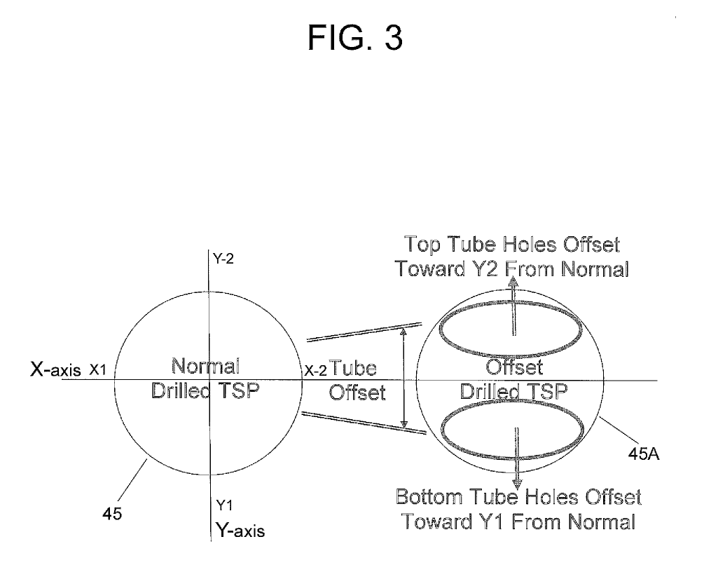

Referring to FIG. 3, there is schematically shown a tube support plate 45 which has a uniformly spaced tube hole pattern, and a tube support plate 45A which, in accordance with the present invention, is fabricated with an offset tube hole pattern. The tube hole pattern on half of the tube support plate 45A is shifted away from the X-axis or support plate centerline along the Y-axis in the direction of Y2, while the other half of the tube hole pattern of the same tube support plate 45A is shifted away from the X-axis or support plate centerline along the Y-axis toward Y1 which is in the opposite direction.

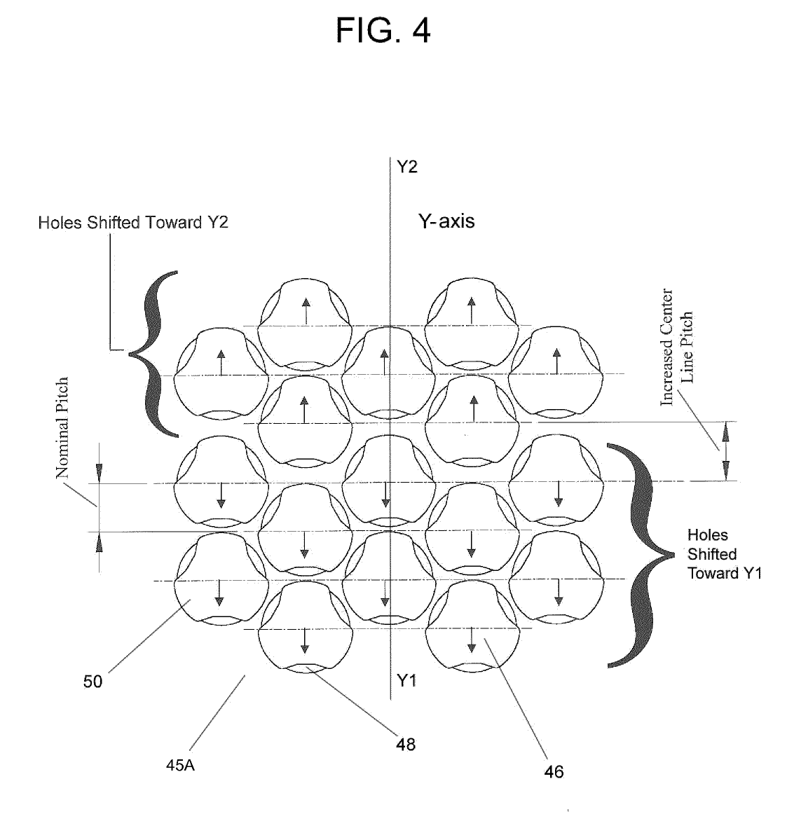

Referring to FIG. 4, there is shown a plan view of a portion of tube support plate 45A characterized by holes or apertures 46, each of which has at least three inwardly protruding lands 48 formed with flat or concave contact surfaces that restrain but do not all engage or contact the outer surface of the tube, not shown, extending through the hole 46. Bights 50 that are intermediate of these inwardly protruding lands 48 are formed in the individual tube support plate holes 46 when the associated tube is lodged in place to establish secondary fluid flow passage through the tube support plate 45A. In accordance with the present invention, the one half of the tube support plate holes 46 are shifted away from the support plate centerline along the Y-axis toward Y2 and the other half of the holes 46 are shifted along the Y-axis toward Y1, by increasing the centerline pitch as compared to the nominal pitch of the holes 46.

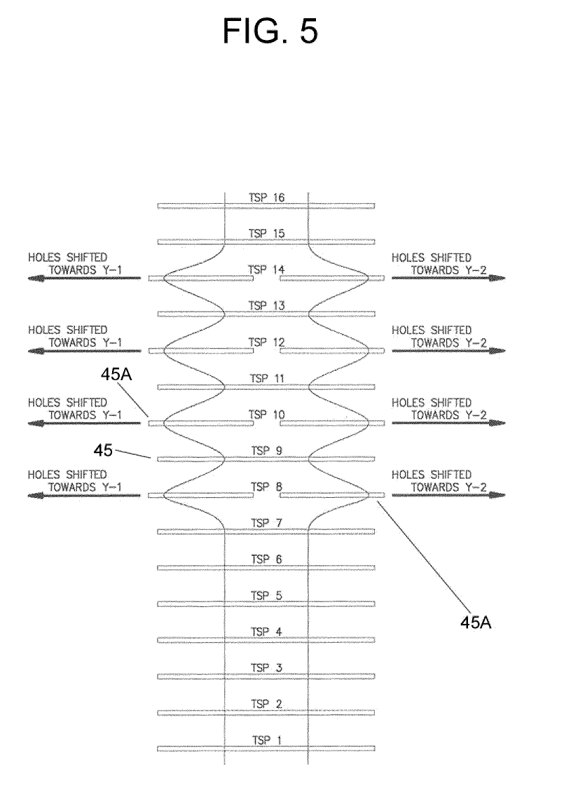

Referring to FIG. 5, there is schematically shown an arrangement of alternately spaced consecutive tube support plates 45 and 45A. The uniformly spaced tube hole pattern of tube support plates 45 and the offset tube hole pattern of the tube support plates 45A adjacent thereto will achieve the desired relative tube hole offset between adjacent tube support plates 45 and 45A. In this arrangement, individual tube support plates are not laterally shifted and the central axis of all the tube support plates are vertically aligned. Relative tube hole offsets resulting from the symmetric drilled offset pattern cause a symmetric displacement of each half of the tube bundle. Because the displaced tube bundle is symmetric about the center line, the contact forces between tubes and holes are symmetric and there is no net lateral load on individual tube support plates. The elimination of the net lateral load prevents potentially detrimental interaction with the shroud at the alignment blocks.

Advantages of the invention include:

During operation, the tube support plates 45A with the offset pattern of tube receiving holes do not cause a net lateral interaction force between the tube support plates and the shroud, thereby eliminating tube support plate edge loads that otherwise would exist with the laterally shifted tube support plates.

Vertical sliding friction loads at the tubular support plate edge alignment blocks are eliminated.

Vertical tie rod loads are minimized thereby minimizing axial tensile or compressive overload of the tie rods during operation.

During assembly, the tube support plates 45A have improved control and accuracy of the offset geometry, since the offset pattern is machined into the tube support plates which are axially aligned. Offset is not dependent upon laterally shifting tube support plates, a process which is difficult to control.

Any in-service deflection of the shroud or degradation of tube support plate positioning blocks does not compromise hole offsets with the “drilled offset” design of the tube support plates 45A.

While specific embodiments and/or details of the invention have been shown and described above to illustrate the application of the principles of the invention, it is understood that this invention may be embodied as more fully described in the claims, or as otherwise known by those skilled in the art, including any and all equivalents, without departing from such principles.

We claim:

1. A flat support plate having an offset pattern of individual tube receiving holes formed therein, the pattern being offset from either the X or Y axis of the support plate.

2. The support plate of claim 1, wherein one half of the offset pattern of tube receiving holes is on one side of the selected axis and the other half is on the other side of the selected axis.

3. The support plate of claim 2, wherein the offset pattern of tube receiving holes is the result of an increased pitch between pattern halves at the selected axis.

4. The method of manufacturing a tube support plate comprising the steps of: selecting either the X or Y axis of the tube support plate; and in the tube support plate, forming a pattern of tube receiving holes offset from the selected axis.

5. The method of claim 4, including the step of dividing the offset pattern of tube receiving holes into two halves.

6. The method of claim 5, including the step of locating one half of the pattern of tube receiving holes on one side of the selected axis and the other half on the other side of the selected axis.

7. The method of claim 6, wherein offsetting the pattern of tube receiving holes includes the step of increasing the pitch between pattern halves at the selected axis.

8. A tube support system for use in a heat exchanger having a cylindrical pressure vessel, a plurality of tubes in spaced parallel relation for flow of fluid there through in indirect heat transfer relation with a fluid flowing there over, a shroud disposed within the pressure vessel and surrounding the tubes, the tube support system comprising a plurality of first and second tube support plates disposed transverse to the tubes, the first support plates having a uniform pattern of tube receiving holes and the second support plates having an offset pattern of tube receiving holes.

9. The tube support system of claim 8, wherein the first tube support plates are placed in spaced alternating fashion with the second support plates.

10. The tube support system of claim 8, wherein the pattern in each of the second tube support plates is offset from either the X or Y axis of the support plate.

11. The tube support system of claim 10, wherein one half of the offset pattern of tube receiving holes is on one side of the selected axis and the other half is on the other side of the selected axis.

12. The tube support system of claim 11, wherein the offset pattern of tube receiving holes is the result of an increased pitch between pattern halves at the selected axis.
